(19) United States
(12) Patent Application Publication
(10) Pub. No.: US 2004/0231783 A1
(43) Pub. Date: Nov. 25, 2004

(54) Method of forming and welding layers of plastic material

(76) Inventor: Keith Joseph Lima, Fall River, MA (US)

Correspondence Address: Keith Lima, 56 Kings Way, Fall River, MA, 02720-8601, US

(21) Appl. No.: 10/439,577

(22) Filed: May 19, 2003

(51) Int. Cl. B32B 31/20

(52) U.S. Cl. 156/245; 156/309.9

(57) ABSTRACT

A method of forming pieces of plastic and welding them together to form large plastic objects by heating plastic sheets until they soften, heating the inner surfaces until they reach their melting point, and pressing them together with a mold to form them to a given and weld them together to form a single object.

### CROSS REFERENCE TO RELATED APPLICATIONS

Not Applicable.

### BACKGROUND

1. Field of Invention

This method relates to the plastic thermoforming process' in which heat, force, and a mold are used to turn flat sheets of plastic into three-dimensional objects. This includes but may not be limited to, Matched-mold or matched-die forming.

2. Description of Prior Art

Plastic thermoforming usually involves two steps: heating and forming. The first step involves heating the material until it softens. This can be accomplished by using different forms of radiant or convection heating. Once the material is softened it can then be formed into the shape desired. This second step is accomplished by moving the softened material into, onto, or between a mold. This is usually accomplished by mechanical, or pneumatic means. At this point the material can be shaped by several different means. In the case of Matched-mold forming the two sides of the mold pressed onto the plastic sheet and the plastic then takes the shape of the molds.

The current process' of thermoforming usually produce objects with a wall thickness unto 0.25 inches. Larger materials are usually injection molded or produced by some other means. Although other methods are commonly used on manufacturing scales, thermoforming is one of the fastest an most economical way of producing plastic objects and products. However producing plastic materials with thermoforming process' becomes increasingly expensive and difficult as the thickness of the plastic sheets gets bigger.

Objects and Advantages

Accordingly, several objects and advantages of my method are:

(a) to provide an easier and perhaps a more economical means of producing plastic materials.

(b) to provide a method of producing larger plastic material than are usually made by thermoforming.

(c) to provide a method of producing large plastic materials at a faster rate and larger scale than most other methods of plastic forming.

Further objects and advantages include but are not limited to: greater manufacturing efficiency, and to produce large plastic materials at a lower cost to the manufacturer.

### DRAWING FIGURES

FIG. 1 shows the conventional method of the plastic thermoforming process.

FIG. 2 shows the new method of plastic thermoforming.

FIG. 3 shows a flow chart of the new method.

### REFERENCE NUMERALS IN DRAWINGS AND FLOWCHART

10 heater

15 heat plastic sheet until softened

20 heater

25 heat inner surfaces of plastic sheets to melting point with heater (30)

30 heater

35 heat inner surfaces of plastic sheets to melting point with heated air

40 air nozzle

45 move plastic sheets into, onto, between, or into any position or location where they can be shaped by a mold.

50 track

55 press molds together to form sheets and weld them together

60 clamp frame

70 plastic sheet

80 plastic sheet

90 plug mold

95 mold table

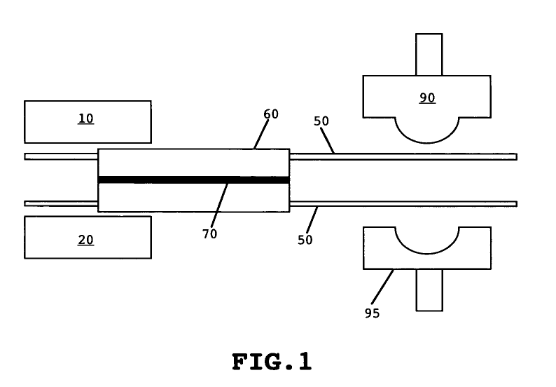

Description FIG. 1

FIG. 1 shows the conventional method of the plastic thermoforming process. The plastic sheet 70 is clamped in the clamp frame 60 which is driven down a track 50. Both sides of the plastic sheet are heated by the heaters, 10 and 20, to soften the plastic evenly. Once this is done the material is then moved between the plug mold 90 and the mold table 95. The plug mold is then pressed into the softened plastic. The plastic then takes the shape of the mold.

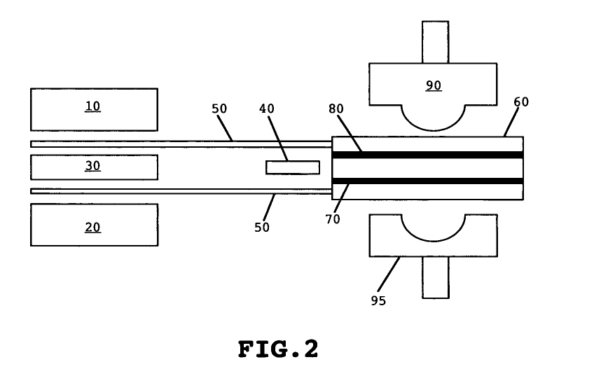

Description FIG. 2

FIG. 2 shows the new method of thermoforming. In the new method the clamp frame 60 holds two sheets of plastic. Heaters 10 and 20 soften the outsides of the sheets while heater 30 softens the inside. If heater 30 melts the inner surface of the sheets then the sheets are moved into the mold and formed. If the sheets have to travel some distance so that the inner surface will not have been melted sufficiently to assist the sheets in welding together properly, then the inner surfaces can be melted by means of heated air.

In this way air nozzle(s) 40 are placed between the sheets and in front of the molds. when the sheets are placed between the molds a blast of hot air from the air nozzle(s) is blown in between the sheet to briefly melt the inner surface of the sheets. Once this is done the molds are pressed into the plastic whereby the softened plastic takes the shape of the mold and the melted portion of the plastics sheets inner surfaces weld the plastic sheets together to form a single object.

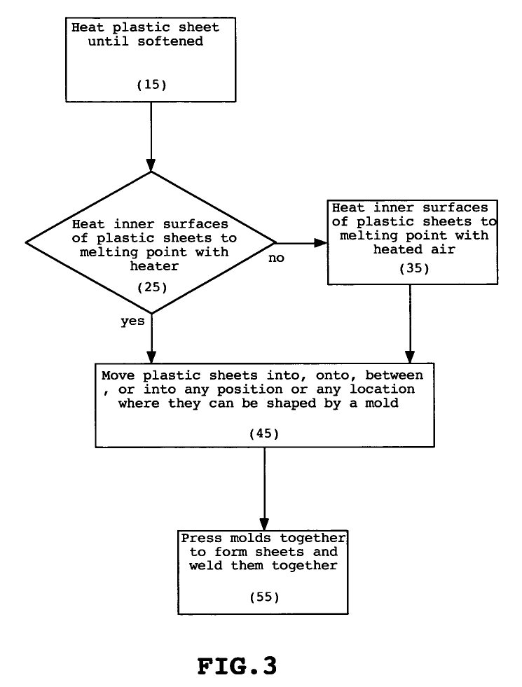

Description FIG. 3

FIG. 3 is a flow chart of the new method.

Advantages

From the description above, a number of advantages of the new method become evident:

(a) Most of the thermoforming equipment in existence today is usually used to form material not much thicker than 0.25 inches. The new method allows for thermoforming of plastic with most of the current equipment and only a few modifications.

(b) Since most of the current equipment can be used, this new method can serve as a much more economical process for producing large plastic objects such as boat hulls and some car parts than other methods of plastic forming.

(c) Since the new method can be implemented economically. And since thermoforming is a very rapid manufacturing process. Large objects can be produced at a much faster rate than most other methods are capable of doing.

Opearation—FIG 2

Operation of a thermoforming machine which uses the new method almost identical to the operation of the current machines with a few exceptions. First, the new machines must be installed with additional heaters such as 30. One additional heater must be installed for every additional layer that is to be formed, and additional control devices must be installed to control them.

Second, air nozzles must be installed in a location were they can direct heated air in between the sheets to be formed and welded together. automatic control devices, or computers can be used to control when the heated air is allowed to come out of the nozzle and to control the pressure thereof.

Third, clamp frames already exist that can hold two plastic sheets on a track 50. larger clamp frames as well as the tracks to accommodate them can be produced and used at the users discretion depending on how many sheets are to be formed and welded at one time.

Operation of the machine would involve placing the sheets 70 and 80 on the clamp frame 60, Placing the clamp frame on the track 50, Heating the sheets with the heaters 10, 20, and 30, rolling the sheets down the track until they are between the the plug mold 90 and 95, blowing the heated air between the sheets to melt them, and clamping the mold parts into the plastic to form and weld them together. In cases where the molds themselves are either round or move to allow for continuous forming rather than continual forming, the air nozzle may be omitted and the middle heater 30 can be used to melt the inner surfaces as the materials are moved through the device uninterrupted.

Conclusion, Ramifications, and Scope of Method

Accordingly, the reader will see that the new method allows for a more economical way of producing thick plastic materials than most current methods allow. While the above description contains many specificity's these should not be construed as limitations on the scope of the method, but rather as an exemplification of one preferred embodiment thereof. Many other variations are possible.

Accordingly, the scope of the invention should be determined not by the drawings illustrated, but by the appended claims and their legal equivalents.

I claim:

1. A method of forming at least 2 pieces of plastic into a given shape and welding them together to produce a single piece of plastic out of said pieces of plastic, comprising the steps of:
a. providing said pieces of plastic, positioning them apart at a given distance and
b. passing said pieces by and in close enough proximity to heating elements as to soften the plastic material wherein some heating elements are sandwiched between but not necessarily in direct contact with said pieces of plastic and having heating elements that are not sandwiched between said pieces of but are located in a location as to heat and soften the outer sides of the outer said pieces of plastic.
c. Heating the inner surfaces of said pieces of plastic in which said inner surfaces may or may not be heated to the melting point of said pieces of plastic.
d. Moving said pieces of softened plastic into, onto, between, or into any position or location where they can be formed and/or shaped by a mold or in any position or location close to said mold.
e. Blowing heated air, and/or an inert gas or gases between said inner surfaces of said pieces of plastic, if the said inner surfaces had not been melted by a heating element and the said inner surfaces are not still in a melted state, wherein said air and or gas or gases is or are at a temperature high enough to melt the inner surfaces of said pieces of plastic.
f. Moving said pieces of plastic into or onto a position or location wherein said mold can be moved onto or into said pieces to form said pieces and weld said pieces together if said pieces of plastic had not already been moved into, or onto a position or location wherein said mold can be closed onto or into said pieces to form said pieces and weld said pieces together.
g. Moving said pieces of plastic into or onto mold, or moving mold onto or into said pieces of plastic whereby said pieces of plastic are then formed and welded together.
